(19) United States
(12) Patent Application Publication
(10) Pub. No.: US 2013/0318271 A1
(43) Pub. Date: Nov. 28, 2013

(54) CABLE HARNESS SWITCHES

(71) Applicants: Michael Schlansker, Los Altos, CA (US); Michael Renne Ty Tan, Menlo Park, CA (US); Nathan Lorenzo Binkert, Redwood City, CA (US); Dale C. Morris, Steamboat Springs, CO (US); Wayne V. Sorin, Palo Alto, CA (US)

(72) Inventors: Michael Schlansker, Los Altos, CA (US); Michael Renne Ty Tan, Menlo Park, CA (US); Nathan Lorenzo Binkert, Redwood City, CA (US); Dale C. Morris, Steamboat Springs, CO (US); Wayne V. Sorin, Palo Alto, CA (US)

(73) Assignee: Hewlett-Packard Development Company, L.P., Houston, TX (US)

(21) Appl. No.: 13/977,912

(22) PCT Filed: Jan. 31, 2011
(86) PCT No.: PCT/US2011/023225

§ 371 Date: Aug. 8, 2013

(51) Int. Cl. G06F 13/40

(52) U.S. Cl. CPC G06F 13/40
USPC 710/300

(57) ABSTRACT

In one implementation, a cable harness switch includes a plurality of input ports, a first plurality of output ports, a second plurality of input ports, and a circuit switch module. Each input port from the plurality of input ports is configured to be coupled to a network link. Each output port from the first plurality of output ports is configured to be coupled to a network link. Each output port from the second plurality of output ports configured to be coupled to a network switch device. The circuit switch module is operatively coupled to the plurality of input ports, the first plurality of output ports, and the second plurality of output ports to define a network circuit including an input port from the plurality of input ports and an output port from the first plurality of output ports and the second plurality of output ports.

### BACKGROUND

Point-to-point network links between network devices such as racks, cabinets, network servers, and/or network switches within communications networks can complicate design, implementation, and configuration of these communications networks. For example, installation of the many cables used to implement such network links can be error-prone, as technicians can, for example, easily plug these cables into incorrect ports at the network devices.

Additionally, as a result of changes in the physical location of network devices of the communications network, cables may be moved to maintain the previous logical network topology within the new physical topology of the communications network. Such reconfiguration is costly and can also be error-prone. Moreover, bandwidth available at the network device and network links can go unused when one or more network devices are inoperative.

### BRIEF DESCRIPTION OF THE DRAWINGS

FIG. 1 is a schematic block diagram of a communications network, according to an embodiment.

FIG. 2 is another schematic block diagram of the communications network of FIG. 1, according to an embodiment.

FIG. 3 is another schematic block diagram of the communications network of FIG. 1 and a configurable cable harness, according to an embodiment.

FIG. 4 is a schematic block diagram of a cable harness switch and a network switch device, according to an embodiment.

FIG. 5 is a schematic block diagram of another cable harness switch and a network switch device, according to an embodiment.

FIGS. 6A, 6B, 6C, 6D, 6E and 6F illustrate physical configurations of a cable harness switches, cables, and a network device, according to one or more embodiments.

FIG. 7 is a schematic block diagram of a communications network, according to an embodiment.

FIG. 8 is a schematic block diagram of another cable harness switch and a network switch device, according to an embodiment.

FIG. 9 is a schematic block diagram of another cable harness switch and a network switch device, according to an embodiment.

FIG. 10 is a schematic block diagram of another cable harness switch and a network switch device, according to an embodiment.

FIG. 11 is a schematic block diagram of a group of cable harness switches and a network switch device, according to an embodiment.

FIG. 12 is a schematic block diagram of the group of cable harness switches and the network switch device of FIG. 11, according to another embodiment.

FIG. 13 is a schematic block diagram of a communications network, according to an embodiment.

FIG. 14 is a schematic block diagram of a circuit switch module and a network switch device, according to an embodiment.

FIG. 15 is a schematic block diagram of an optical circuit switch module and a network switch device, according to an embodiment.

### DETAILED DESCRIPTION

Communications networks such as communications networks within datacenters are typically implemented using point-to-point network (or communications) links (or links) between network devices (e.g., racks, cabinets, network switch devices, network servers, and/or other computing devices within the communications network). These point-to-point links are commonly realized by cables or cable assemblies that are connected to the network devices.

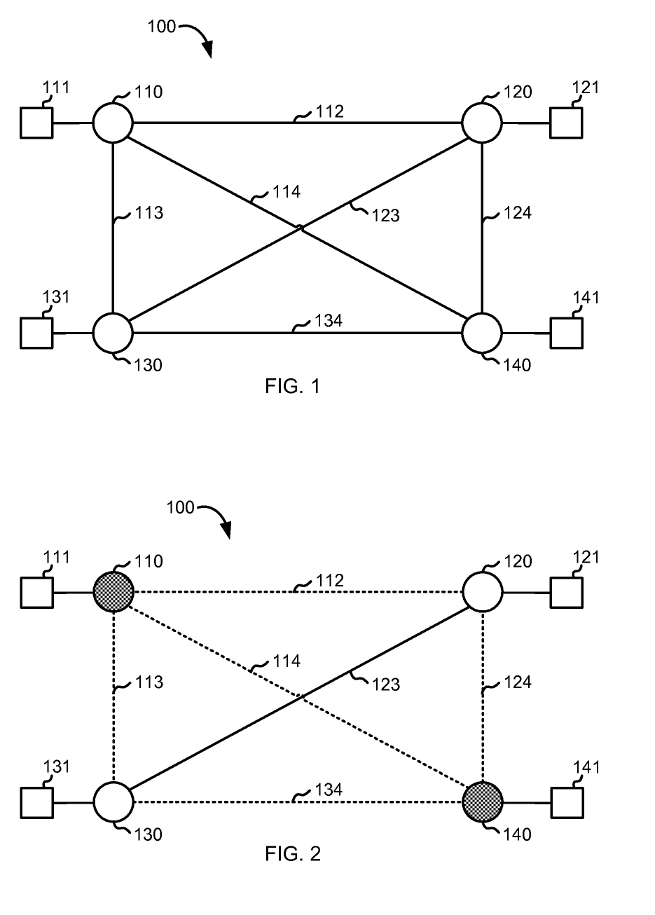

As an example, FIG. 1 is a schematic block diagram of a communications network, according to an embodiment. Communications network 100 includes network devices 110, 120, 130 and 140 and links 112, 113, 114, 123, 124 and 134. Links 112, 113, 114, 123, 124 and 134 can each include one or more links (i.e., sub-links). For example, one or more of links 112, 113, 114, 123, 124 and 134 can be a bi-directional link including two unidirectional sub-links via which network devices 110, 120, 130 and 140 can communicate one with another.

Network device 110 is in communication with (or operably coupled to) network devices 120, 130, and 140 via links 112, 113, and 114, respectively. Network device 120 is in communication with network devices 110, 130, and 140 via links 112, 123, and 124, respectively. Network device 130 is in communication with network devices 110, 120, and 140 via links 113, 123, and 134, respectively. Network device 140 is in communication with network devices 110, 120, and 130 via links 114, 124, and 134, respectively. Thus, each of network devices 110, 120, 130 and 140 can communicate with (i.e., exchange signals or symbols representing data) any of the others of network devices 110, 120, 130 and 140.

In a specific example, network devices 110, 120, 130 and 140 are network switch devices that are operatively coupled to computing devices 111, 121, 131 and 141, respectively. Computing devices 111, 121, 131 and 141 are, for example, processing devices (e.g., network servers) and/or storage devices (e.g., data stores). Computing devices 111, 121, 131and 141 are in communication one with another via network devices 110, 120, 130 and 140 and links 112, 113, 114, 123, 124 and 134. That is, computing device 111 can send a data packet to computing device 114 as follows. Computing device 111 sends the data packet to network device 110 and network device 110 determines via which link of links 112, 113 and 114 to forward the data packet toward computing device 141. Network device 110 determines that the data packet should be forwarded to network device 140 via link 114 and sends the data packet to network device 140 via link 114. Network device 140 receives the data packet via link 114 and determines that computing device 141 is coupled to network device 140. Network device 140 then forwards the data packet to computing device 141.

Network devices within a communications network such as network devices 110, 120, 130 and 140 each typically provide or support sufficient bandwidth (or throughput) to handle (i.e., process and/or interpret) network traffic at all the links of that network device. More specifically, for example, network device 110 can process network traffic that is received and/or sent via each of links 112, 113 and 114. For example, network devices 110, 120, 130 and 140 can be cabinets within a datacenter, each of which houses a network switch device such as a Top of Rack (“TOR”) switch and multiple network servers including computing devices 111, 121, 131 and 141, respectively. Links 112, 113, 114, 123, 124 and 134 are connections between the TOR switch of each cabinet and that TOR switch can process all the traffic (i.e., data to and from computing devices 111, 121, 131 and 141 and/or other network servers) that is received and/or sent via the three links coupled to that TOR switch.

Because each of network devices 110, 120, 130 and 140 provides sufficient bandwidth to process data received via three links, bandwidth within communications network 100 is wasted or unused when one of network devices 110, 120, 130 and 140 is inoperative. Moreover, because the cables coupled to an inoperative network device do not typically transfer (or carry) data because the network device at one terminus of those cables is inoperative, the bandwidth available at those cables is also wasted or unused. For example, FIG. 2 is another schematic block diagram of the communications network of FIG. 1 in which network devices 110 and 140 are inoperative, according to an embodiment. Network devices 110 and 140 can become inoperative due to a number of factors. For example, network devices can become inoperative due to a hardware or software failure at the network devices. Alternatively, for example, a network device can be inoperative after being disabled by a network management entity to reduce energy consumption within a datacenter if utilization of the network device falls below a predetermined threshold.

Because network devices 110 and 140 are inoperative, links 112, 113, 114, 124 and 134 do not carry data. That is, because network devices 110 and 140 (i.e., the endpoints or terminuses of links 112, 113, 114, 124 and 134) are inoperative, no symbols are transmitted via links 112, 113, 114, 124 and 134. In other words, the bandwidth of network devices 110 and 140 and link 114 is unused, and bandwidth of network devices 120 and 130 and links 112, 113, 124 and 134 is wasted. Thus, although network devices 120 and 130 have sufficient bandwidth to handle network traffic transmitted and/or received via three links, network devices 120 and 130 utilize only link 123. Said differently, bandwidth is wasted (e.g., at network devices 120 and 130 and links 112, 113, 124 and 134) because links 112, 113, 124 and 134 are unused.

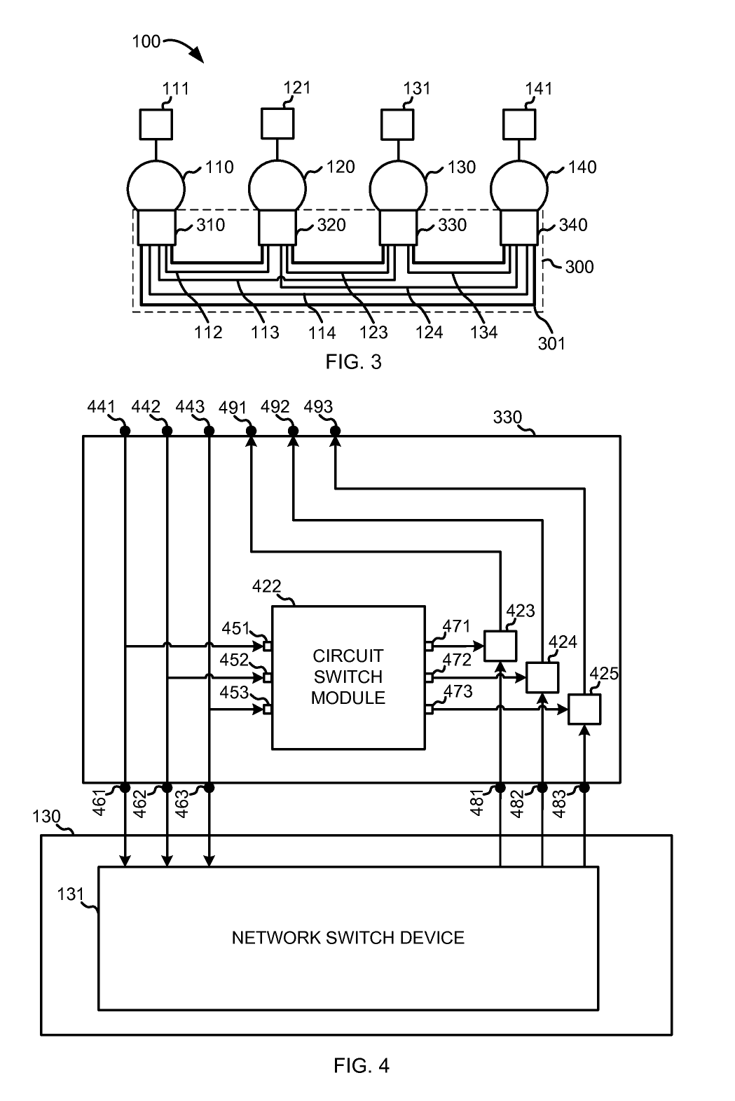

Embodiments discussed herein define network circuits from unused links within a communications network. For example, embodiments disclosed herein include configurable (or programmable) cable harnesses that connect multiple cables together to define a circuit between ports of network devices that are not directly connected one to another. As a specific example, FIG. 3 is another schematic block diagram of the communications network of FIG. 1 and a configurable cable harness, according to an embodiment. FIG. 3 illustrates communications network 100 in which network devices 110, 120, 130 and 140 are connected one to another by configurable cable harness 300 and the computing devices 111, 121, 131 and 141, respectively. Configurable cable harness 300 includes cable harness switches 310, 320, 330 and 340 and links 112, 113, 114, 123, 124 and 134 within cable sheath 301. Links 112, 113, 114, 123, 124 and 134 can be electrical cables, optical cables, and/or some other medium. As illustrated in FIG. 3, network device 110 is coupled to configurable cable harness 300 via cable harness 310, network device 120 is coupled to cable assembly 300 via cable harness 320, network device 130 is coupled to cable assembly 300 via cable harness switch 330, and network device 140 is coupled to cable assembly 300 via cable harness 340.

Cable harness switches 310, 320, 330 and 340 are assemblies at which links 112, 113, 114, 123, 124 and 134 can be coupled one to another to define network circuits within communications network 100. For example, each of cable harness switches 310, 320, 330 and 340 can include a circuit switch module (not shown) that can be configured to define a network circuit by coupling one link with another link within the cable harness. As illustrated in FIG. 3, links 112, 113 and 114 are coupled to network device 110 via cable harness switch 310; links 112, 123 and 124 are coupled to network device 120 via cable harness switch 320; links 113, 123 and 134 are coupled to network device 130 via cable harness switch 330; and links 114, 124 and 134 are coupled to network device 140 via cable harness switch 340. Although network devices 110 and 140 are inoperative as illustrated in FIG. 2, cable harness switches 310 and 340 can be configured (or programmed) to define a network circuit including links 113 and 112 and a network circuit including links 134 and 124, respectively. In other words, the circuit switch modules at cable harness switches 310 and 340 can be configured to operatively couple links 113 and 112 and links 134 and 124, respectively.

When cable harness switches 310 and 340 are configured as discussed above, network devices 120 and 130 are in communication one with another not only via link 123, but also via the network circuit including links 112 and 113 and the network circuit including links 124 and 134. That is, symbols representing data can be exchanged between network devices 120 and 130 via link 123, an aggregate of links 124 and 134, and an aggregate of links 112 and 113. Thus, computing device 121 is in communication with computing device 131 via network device 120, cable harness switch 320, cable harness switch 330, network device 120 and each of link 123, the network circuit including links 112 and 113 and the network circuit including links 124 and 134. Therefore, bandwidth available at network devices 120 and 130 and links 112, 113, 124 and 134 due to the inoperative state of network devices 110 and 140 can be used to exchange data between computing devices 121 and 131 and/or network devices 120 and 130 via the network circuit including links 112 and 113 and the network circuit including links 124 and 134.

As used in this specification, the singular forms “a,” “an,” and “the” include plural referents unless the context clearly dictates otherwise. Thus, for example, the term “circuit switch module” is intended to mean one or more circuit switch modules or a combination of circuit switch modules. Additionally, as used herein, the term “module” refers to hardware, circuitry and/or software, firmware, programming, machine- or processor-readable instructions, commands, or code that are stored at a memory and executed or interpreted at a processor.

A network link (or link) is a physical connection between two or more network devices (i.e., between a transmitter and a receiver) that is independent of (or separate from) the physical medium via which the link is implemented. For example, a link can be an electrical connection between two network switch devices or an optical connection between two network switch devices. Moreover, a link can be a collection or aggregate of links (i.e., sub-links). For example, a bi-directional link can include two links—one link being an uplink and the other link being a downlink.

A network circuit (or circuit) is a collection of links and/or network devices via which two or more network devices are in communication one with another. Said differently, symbols (or signals) representing data transferred via a circuit traverse that circuit independent of the data represented by the symbols. That is, the circuit is independent of (or not sensitive to) the data transferred via the circuit and is not altered by the data transferred via the circuit until the circuit is reconfigured. Rather, the circuit is defined (or configured) based on signals external (or separate from) to the data represented by the symbols via the circuit. Said differently, the circuit does not change in response to the data transferred via the circuit. As a specific example, Ethernet data packets transferred via a circuit are not packet switched within the circuit. Rather, each data packet is transferred along the circuit independent of the content (or information or data) of that data packet.

In some embodiments, symbols (or data represented by those symbols) can be cached within a circuit. That is, input (or ingress) ports and/or output (or egress) ports within a circuit can include memory (or other storage elements) at which symbols or data are temporarily stored before being further transmitted within the circuit. In other words, a circuit can include store and forward functionality.

A cable is the physical medium or components via which a link is realized or implemented. For example, a cable can be an electrically conductive wire such as a copper wire. As another example, a cable can be a waveguide such as an optical fiber. Groups of cables can be aggregated into cable assemblies that include multiple cables. Typically, cable assemblies are housed or bound in a housing such as a protective sheath to protect the cables and/or secure the cables together.

A cable harness is an assembly or device that includes one or more cables (i.e., a cable assembly) and one or more connectors via which these cables are coupled to other devices. That is, two or more devices can be coupled one to another via a cable harness. Said differently, a cable harness is typically disposed or situated between two or more devices to allow communication (e.g., exchange of symbols representing data) among these devices. In some embodiments, a cable harness can be a configurable cable harness including one or more cable harness switches. A configurable cable harness includes one or more cable harness switches at which network circuits can be dynamically (or reconfigurably) defined by coupling two or more cables (or links) of the configurable cable harness one to another at one or more of the cable harness switches.

Moreover, cable harnesses can include multiple portions or assemblies that are coupled together to form the cable harness. For example, a configurable cable harness can include a cable assembly, a cable harness switch, and a group of connectors. Furthermore, some portions of a cable harness can be internal to a device (e.g., a network switch device or cabinet or rack housing a network switch device) and other portions of that cable harness can be external to that device. Said differently, a cable harness or one or more portions of a cable harness can be integrated into a network device.

A port is a component of a device or module such as a cable, a cable assembly, a cable harness, or a network switch device at which signals, symbols, or data are received (i.e., an input port) and/or transmitted (i.e., an output port). A port can be, for example, a link coupled to a device, a connector, a contact (e.g., an electrically conductive contact such as a bare copper wire, a connector pin, a circuit board trace, or a connector receptacle), a waveguide such as an optical fiber, a lens, and/or groups thereof. Some ports are operatively coupled to circuitry and/or logic such as store and forward circuitry.

In some embodiments, a port can be included at a connector having one or more features or elements to support a mechanical connection of, for example, that connector to another connector. For example, a connector including a port of a cable harness can include features (and a cable connector can include complementary features) such as protrusions, ridges, flanges, indentations, magnets, and/or other features to form a compression fit, a friction fit, a snap fit, an annular lock, a magnetic coupling, and/or other mechanical connection between the port and a cable. Alternatively, for example, a cable harness can include a cable and a cable connector (i.e., a connector at one end of the cable). The cable connector can include (or house) a port of the cable harness and can be mechanically coupled to a complementary connector at a network switch device that includes a port of the network switch device via a compression fit, a friction fit, a snap fit, an annular lock, and/or other mechanical connection.

Moreover, a port can be configured or adapted to be coupled to a particular type or class of device, connector, link, and/or other port. For example, a port can have a particular form factor or be included at a connector that is configured to form a complimentary fit with a device, another connector, a link, and/or another port. Additionally, for example, a port can have or support operational characteristics via which it is configured or configurable to be coupled to a device, a connector, a link, and/or another port. For example, a signal type (e.g., electrical signal or optical signal), data rate, signal amplitude, and/or protocol that is supported by a port can be adapted, configured, or selected to be compatible with a device, a connector, a link, and/or another port such that the port can be coupled to that device, connector, link, and/or other port.

A circuit switch module is a configurable device that includes input ports and output ports and defines one or more paths between input ports and output ports. That is, a circuit switch module can realize a circuit by defining a path for symbols or signals (or a signal path) that represent data between an input port of the circuit switch module to which a link is coupled and an output port of the circuit switch module to which another link is coupled based on or in response to configuration commands or instructions (or signals representing configuration commands or instructions). In some embodiments, a circuit switch module can include multiple groups of input ports and multiple groups of output ports. Moreover, in some embodiments, a signal path can be defined between any port of a group of input ports and any port of a first group of output ports, but between only a specific (or associated) port of a second group of output ports for each port of the group of input ports and that port of the group of input ports. That is, within a circuit switch module some ports have a one-to-one relationship with other ports and some ports have a one-to-many (or to-any) relationship with other ports.

A network switch device is a device such as a network switch, network router, network gateway, and/or network bridge that receives and transmits data that is transferred within a communications network between network devices (e.g., network storage devices and network server devices). Typically, a network switch device is a packet switching device that transmits or forwards data packets within a communications network based on data (e.g., a source address, a destination address, and/or other data) within the data packets transferred within the communication network. Network switch devices are commonly included within a cabinet or rack that also includes computing devices such as processing devices (e.g., network server devices) and/or storage devices (e.g., network storage devices).

FIG. 4 is a schematic block diagram of cable harness switch 330 and a network switch device at network device 130, according to an embodiment. Cable harness switch 330 includes circuit switch module 422, circuit switch modules 423, 424 and 425, input ports 441, 442,443, 481, 482 and 483, and output ports 461, 462, 463, 491, 492 and 493. Circuit switch module 422 is coupled to input ports 441, 442 and 443 and output ports 461, 462 and 463 at input ports 451, 452 and 453 of circuit switch module 442, respectively, and to circuit switch modules 423, 424 and 425 via output ports 471, 472 and 473 of circuit switch module 422, respectively. More specifically, circuit switch module 422 is coupled to circuit switch module 423 via port 471 and a port (not shown) of circuit switch module 423, to circuit switch module 424 via port 481 and a port (not shown) of circuit switch module 424, and to circuit switch module 425 via port 473 and a port (not shown) of circuit switch module 425. Circuit switch module 422 is coupled to ports 441, 442, 443, 461, 462 and 463 and to circuit switch modules 423, 424 and 425 via one or more links such as, for example, cables (e.g., electrical cables or fiber optic cables), wires, circuit board traces, waveguides within a substrate such as a circuit board, and/or other links. Circuit switch modules 423, 424 and 425 are similarly coupled to ports 481 and 491, 482 and 492, and 483 and 493, respectively. Additionally, cable harness switch 330 is operatively coupled to network switch device 131 of network device 130 at ports 461, 462, 463, 481, 482 and 483.

Circuit switch module 422 is configurable to couple any of ports 451, 452 and 453 (input ports) to any of ports 471, 472 and 473 (output ports). Additionally, circuit switch module 423 is configurable to couple one of port 471 and port 481 to port 491, circuit switch module 424 is configurable to couple one of port 472 and port 482 to port 492, and circuit switch module 425 is configurable to couple one of port 473 and port 483 to port 493. That is, port 471 is coupled to a port (not shown) at circuit switch module 423, port 481 is coupled to a port (not shown) at circuit switch module 423, and port 491 is coupled to a port (not shown) at circuit switch module 423. Circuit switch module 423 can couple one of the ports to which ports 471 and 481 are coupled to the port coupled to port 491. Similarly, port 472 is coupled to a port (not shown) at circuit switch module 424, port 482 is coupled to a port (not shown) at circuit switch module 424, and port 492 is coupled to a port (not shown) at circuit switch module 424. Circuit switch module 424 can couple one of the ports to which ports 472 and 482 are coupled to the port coupled to port 492. Furthermore, port 473 is coupled to a port (not shown) at circuit switch module 425, port 483 is coupled to a port (not shown) at circuit switch module 425, and port 493 is coupled to a port (not shown) at circuit switch module 425. Circuit switch module 425 can couple one of the ports to which ports 473 and 483 are coupled to the port coupled to port 493. Thus, any of ports 441, 442 and 443 can be coupled to any of output ports 491, 492 and 493 via circuit switch module 422 and one or more of circuit switch modules 423, 424 and 425. In some embodiments, a subset of ports 451, 452 and 453 can be coupled to a subset of ports 471, 472 and 473 at circuit switch module 422. For example, ports 451 and 452 can be coupled to either of ports 471 and 472, and port 453 can be coupled to either of ports 472 and 473.

When network switch device 131 is operative, for example, cable harness switch 330 can function as a pass-through or transparent device with respect to network switch device 131. That is, signals received at ports 441, 442 and 443 are received at network switch device 131 via ports 461, 462 and 463. Circuit switch device 422 can be configured such that ports 451, 452, 453, 471, 472 and 473 are open or not connected. Moreover, circuit switch devices 423, 424 and 425 can be configured to couple port 481 to port 491, port 482 to port 492, and port 483 to port 493. Because circuit switch devices 423, 424 and 425 can be configured to couple port 481 to port 491, port 482 to port 492, and port 483 to port 493, ports 451, 452 and 453 can be coupled to ports 471, 472 and 473 via circuit switch module 422 rather than configured to be open as discussed above without conflicting the signals transmitted from network switch device 131 a ports 481, 482 and 483. Thus, signals transmitted from network switch device 131 are output at ports 491, 492 and 493.

Cable harness switch 330 can also be configured, for example when network switch device 131 is inoperative, to bypass network switch device 131. That is, cable harness switch 330 can be configured to couple ports 441, 442 and/or 443 to ports 491, 492 and/or 493 via circuit switch module 422 and circuit switch modules 423, 424 and 425.

As a specific example, network switch device 131 can be a TOR switch at network device 130. Thus, with reference to FIGS. 3 and 4, link 113 can be coupled to ports 441 and 491 (i.e., link 113 includes two cables—one cable coupled to port 441 and the other cable coupled to port 491), link 123 can be coupled to ports 442 and 492, and link 134 can be coupled to ports 443 and 493. If network switch device 131 becomes inoperative or disabled, cable harness switch 330 can be configured to couple links 113 and 123, links 113 and 134, or links 123 and 134. In other words, cable harness switch 330 can be configured as follows: to couple network device 110 to network device 120 by defining a circuit including link 113, link 123, and cable harness switch 330; to couple network device 110 to network device 140 by defining a circuit including link 113, link 134, and cable harness switch 330; or to couple network device 120 to network device 140 by defining a circuit including link 123, link 134, and cable harness switch 330.

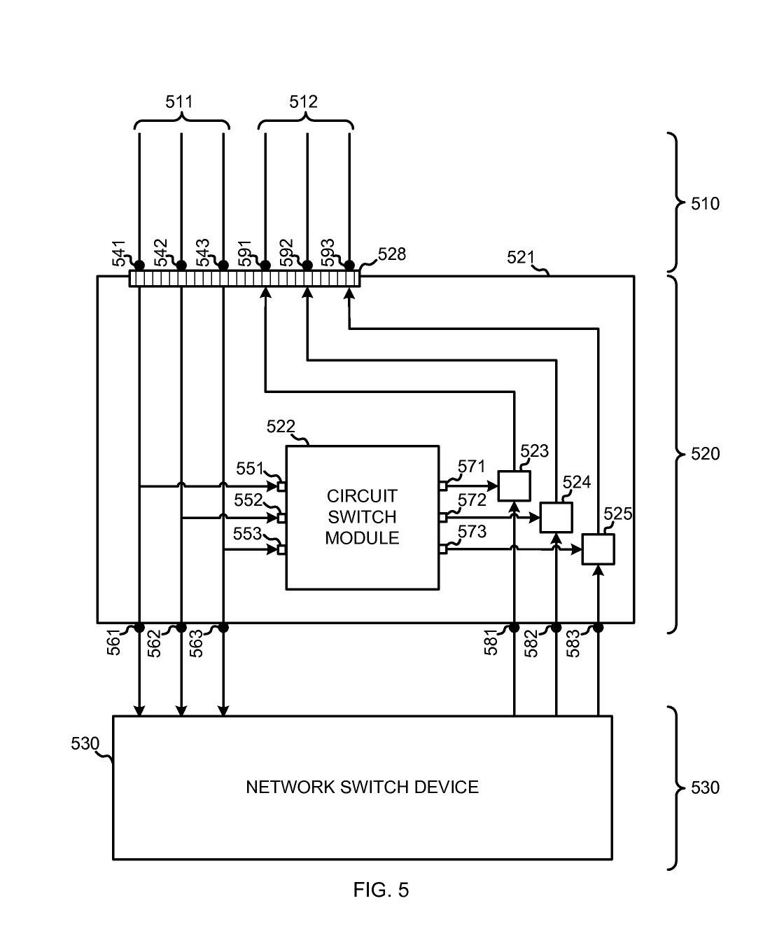

FIG. 5 is a schematic block diagram of another cable harness switch and a network switch device, according to an embodiment. Cable harness switch 521able harness switch 521 includes circuit switch module 522, circuit switch modules 523, 524 and 525, input ports 541, 542, 543, 581, 582 and 583 and output ports 561, 562, 563, 591, 592 and 593. Additionally, cable harness switch 521 includes opto-electrical module 528. Opto-electrical module 528 include electro-optical converters and opto-electrical converters to convert electrical signals to related or associated optical signals and to convert optical signals to related or associated electrical signals, respectively. More specifically, cables 511 and cables 512 are optical cables or waveguides via which optical signals are transferred. Opto-electrical module 528 includes a first group of ports (not shown) to which cables 511 are coupled via ports 541, 542 and 543. A group of opto-electrical converters at opto-electrical module 528 are also coupled to the first group of ports such that each cables of cables 511 is operatively coupled to one of the opto-electrical converters at opto-electrical module 528. These opto-electrical converters convert optical signals received from cables 511 to electrical signals that are provided to ports 551, 552, 553, 561, 562 and 563, which are also each coupled to an opto-electrical converter from the group of opto-electrical converters.

Similarly, opto-electrical module 528 includes a second group of ports (not shown) to which cables 512 are coupled via ports 591, 592 and 593. A group of electro-optical converters at opto-electrical module 528 are also coupled to the second group of ports such that each cables of cables 512 is operatively coupled to one of the electro-optical converters at opto-electrical module 528. These electro-optical converters convert electrical signals received from ports of circuit switch modules 523, 524 and 525, which are also each coupled to an electro-optical converter from the group of electro-optical converters, to optical signals that are provided to cables 512. Thus, cable harness switch 521 can be in optical communication with other cable harnesses and/or network devices (i.e., can communicate by exchanging optical signals), but use electrical signals internally. That is, circuit switch module 522, circuit switch modules 523, 524 and 523, and ports 541, 542, 543, 551, 552, 553, 561, 562, 563, 571, 572, 573, 581, 582, 583, 591, 592 and 593 are electrical components.

Therefore, circuit switch module 522 is coupled to input ports 541, 542 and 543 via the opto-electrical converters of opto-electrical module 528 at ports 551, 552 and 553, respectively, and to circuit switch modules 523, 524 and 525 via ports 571, 572 and 573, respectively. Additionally, cable harness switch 521 is operatively coupled to network switch device 531 by ports 561, 562, 563, 581, 582 and 583. Accordingly, cable harness switch 521 communicates with network switch device 531 using electrical signals.

As illustrated in FIG. 5, cables 511 and 512, cable harness switch 521, and network switch device 530 can be discussed with reference to different domains: interconnect domain 510, cable harness switch domain 520, and network device domain 530. Interconnect domain 510 is an optical domain. That is, communication within interconnect domain 510 is optical communication realized by optical fibers, optical waveguides, and/or other optical signal transmission media (i.e., media that supports transmission of optical signals). Cable harness switch domain 520 and network device domain 530 are electrical domains. In other words, communication within cable harness switch domain 520 and network device domain 530 is electrical communication realized by wires and/or other electrically conductive media (i.e., media that supports transmission of electrical signals). Thus, opto-electrical module 528 defines an interface between interconnect domain 510 and cable harness switch domain 520 or, said differently, between an optical domain and an electrical domain. Similarly, ports 561, 562, 563, 581, 582 and 583 define an interface between cable harness switch domain 520 and network device domain 530.

Circuit switch module 522 is configurable to couple any of ports 551, 552 and 553 (input ports) to any of ports 571, 572 and 573 (output ports). Additionally, circuit switch module 523 is configurable to couple one of port 571 and port 581 to port 591, circuit switch module 524 is configurable to couple one of port 572 and port 582 to port 592, and circuit switch module 525 is configurable to couple one of port 573 and port 583 to port 593. Thus, any of ports 541, 542 and 543 can be coupled to any of output ports 591, 592 and 593 via circuit switch module 522 and one or more of circuit switch modules 523, 524 and 525. In some embodiments, a subset of ports 551, 552 and 553 can be coupled to a subset of ports 571, 572 and 573 at circuit switch module 522. For example, ports 551 and 552 can be coupled to either of ports 571 and 571, and port 553 can be coupled to either of ports 572 and 573.

Because cable harness switch 521 can couple ports 541, 542 and 543 to ports 591, 592 and 593, cables 511 can be coupled to cables 512 to define a network circuit through cable harness switch 521. In other words, similar to, for example, cable harness switch 330, cable harness switch 521 can be configured (or programmed) to define a network circuit including multiple links. In the example illustrated in FIG. 5, the network circuit includes links that are implemented at optical cables and these optical cables are coupled electrically within cable harness switch 521. That is, the optical signals exchanged via the links (i.e., cables 511) are converted to electrical signals at opto-electrical module 528 and transferred via circuit switch module 522 and circuit switch modules 532, 524 and 525 to other links (i.e., cables 512) after being converted from electrical signal to optical signals at opto-electrical module 528. In other embodiments, optical links can be coupled optically within an optical cable harness. That is, a cable harness that coupled optical links without intermediately converting optical signals to electrical signals.

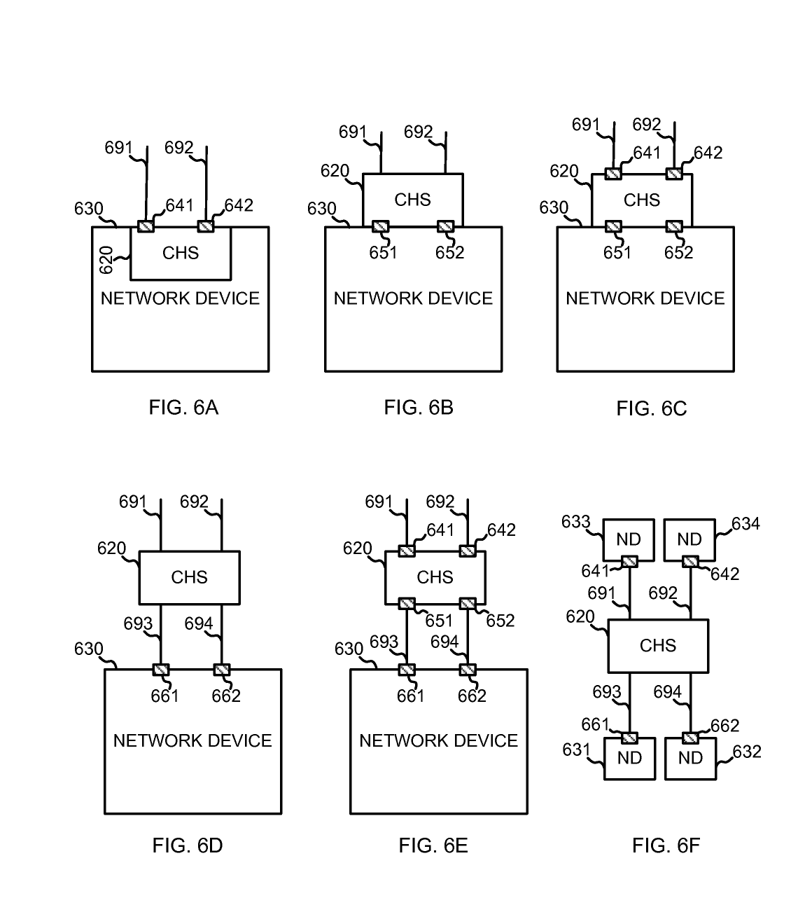

FIGS. 6A, 6B, 6C, 6D, 6E and 6F illustrate physical configurations of a cable harness switch, cables, and a network device, according to one or more embodiments. FIG. 6A illustrates an example of cable harness switch 620 that is included within network device 630. Network device 630 is, for example, a cabinet or rack that includes a TOR switch coupled to cable harness switch 620 and processing devices (e.g., servers) and/or storage devices coupled to the TOR switch and in communication with other processing devices and/or storage devices via the TOR switch, cable harness switch 620 and cables 691 and 692. That is, cable harness switch 620 is integrated at network device 630. Cables 691 and 692 are operatively coupled to cable harness switch 620 via connectors 641 and 642, respectively. Thus, some ports of cable harness switch 620 are included at connectors 641 and 642 and other ports are coupled to other connectors and/or devices (e.g., a network switch device) within network device 630.

Connectors 641 and/or 642 can include multiple portions. For example, connectors 641 can include a plug portion coupled to cable 691 and a receptacle portion at cable harness switch 620 that receives and engages the plug portion such that the plug portion is removable coupled to the receptacle portion. Moreover, cables 691 and 692 can each include multiple links. Said differently, cables 691 and 692 can each be a cable assembly that includes multiple cables.

FIG. 6B illustrates an example of cable harness switch 620 in which cables 691 and 692 are integrated with (or hard-wired to) cable harness switch 620 and cable harness switch 620 is coupled to network device 630 via connectors 651 and 652. Thus, some ports of cable harness switch 620 are included at cables 691 and 692 (e.g., at cable connectors of cables 691 and 692) and other ports are included at connectors 651 and 652. Network device 630 is, for example, a cabinet or rack that includes a TOR switch coupled to cable harness switch 620 and processing devices (e.g., servers) and/or storage devices coupled to the TOR switch and in communication with other processing devices and/or storage devices via the TOR switch, cable harness switch 620 and cables 691 and 692.

Similar to connectors 641 and 642, connectors 651 and 652 can include multiple portions such as a plug portion at cable harness switch 620 and a receptacle portion at network device 630. The receptacle portion receives and engages the plug portion such that the plug portion is removable coupled to the receptacle portion. As a specific example, a plug portion can include features—and a receptacle portion can include complementary features—such as protrusions, ridges, flanges, indentations, magnets, and/or other features to form a compression fit, a friction fit, a snap fit, an annular lock, a magnetic coupling, and/or other mechanical connection between the plug portion and the receptacle portion. Although not illustrated as such in FIG. 6B, cables 691 and 692 can be aggregated within a common cable sheath coupled (not shown) to cable harness switch 620.

FIG. 6C illustrates an example of cable harness switch 620 in which cables 691 and 692 are coupled to cable harness switch 620 via connectors 641 and 642, respectively, and cable harness switch 620 is coupled to network device 630 via connectors 651 and 652. Thus, some ports of cable harness switch 620 are included at connectors 641 and 642 and other ports are included at connectors 651 and 652. Network device 630 is, for example, a cabinet or rack that includes a TOR switch coupled to cable harness switch 620 and processing devices (e.g., servers) and/or storage devices coupled to the TOR switch and in communication with other processing devices and/or storage devices via the TOR switch, cable harness switch 620 and cables 691 and 692.

FIG. 6D illustrates an example of cable harness switch 620 in which cables 691, 692, 693 and 694 are integrated with cable harness switch 620, and cable harness switch 620 is coupled to network device 630 via cables 693 and 694 using connectors 661 and 662. For example, cable harness switch 620 can be a portion of a configurable cable harness including multiple cable harness switches and be coupled to the other cable harness switches of the configurable cable harness via cables 691 and 692. As illustrated in FIG. 6D, cable harness switch 620 is coupled to network device 630 by cables 693 and 694 and connectors 661 and 662 rather than directly by connectors 651 and 652 as illustrated in FIG. 6B.

FIG. 6E illustrates an example of cable harness switch 620 in which cables 691 and 692 are coupled to cable harness switch 620 via connectors 641 and 642, respectively, and cable harness switch 620 is coupled to network device 630 via connectors 651 and 652, cables 693 and 694, and connectors 661 and 662. In other words, cable harness switch 620 is separable or removable from cables 691, 692, 693 and 694.

FIG. 6F illustrates an example in which network devices 631, 632, 633 and 634are each coupled to cable harness switch 620. As illustrated in FIG. 6F, cables 691, 692, 693 and 694 are integrated with cable harness switch 620. In other embodiments, cables 691, 692, 693 and 694 can be separable from cable harness switch 620 using connectors, for example, as illustrated in FIGS. 6C and 6E. As discussed above, cables 691 and 692 and, here, cables 693 and 694 can each be cable assemblies that include multiple cables. Thus, a single cable harness switch can be coupled to multiple network devices.

In some embodiments, cables 691 and 692 can be coupled to cable harness switch 620 via more or fewer connectors than illustrated in FIGS. 6A, 6B, 6C, 6D, 6E and /or 6F. Similarly, cable harness switch 620 can be coupled to network device 630 via more of fewer connectors. As illustrated in FIGS. 6C, 6D, 6E and 6f, cable harness switch 620 is modular. More specifically, for example, in FIG. 6C, cable harness switch 620 is modular with respect to cables 691 and 692 and network device 630. That is, cable harness switch 620 is separate from cables 691 and 692 and network device 630. As another example, in FIG. 6E, cable harness switch 620 is modular with respect to cables 691, 692, 693, and 693 and network device 630. In other words, cable harness switch 620 is separate from cables 691, 692, 693, and 693 and network device 630.

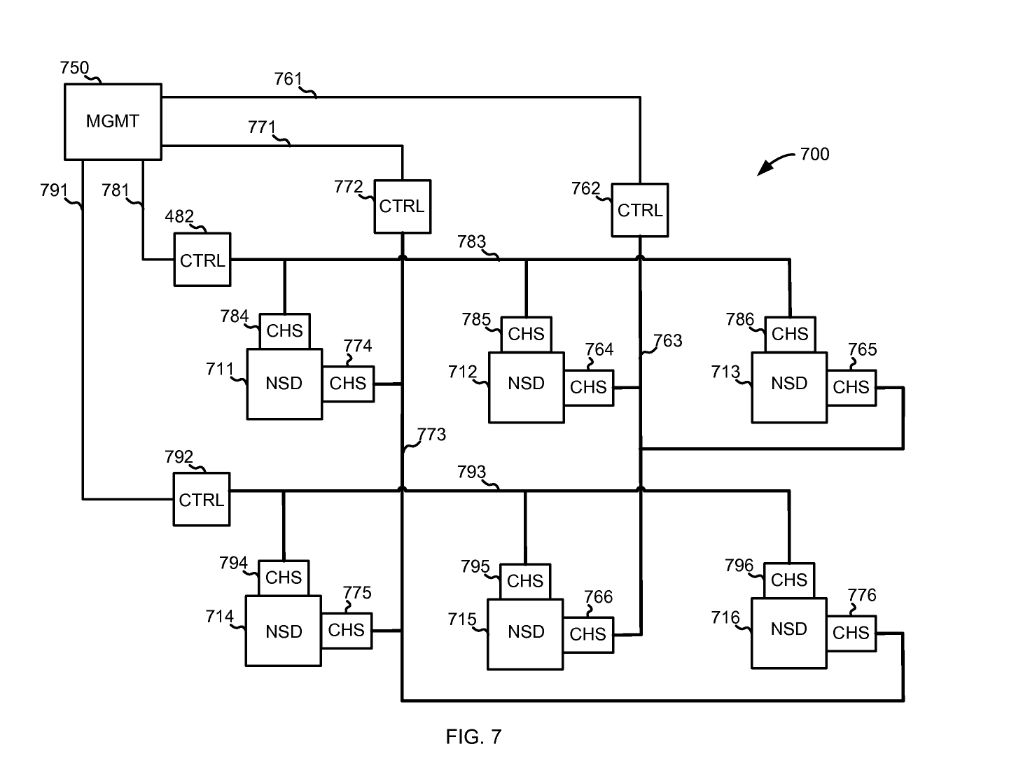

FIG. 7 is a schematic block diagram of a communications network, according to an embodiment. Communications network 700 includes network switch devices 711, 712, 713, 714, 715 and 716. Network switch devices 712, 713 and 715 are coupled to cable harness 763 via cable harness switches 764, 765 and 766, respectively. Cable harness 763 includes at least three links: a link between network switch devices 712 and 713, a link between network switch devices 712 and 715, and a link between network switch devices 713 and 715. Network switch devices 711, 714 and 716 are coupled to cable harness 773 via cable harness switches 774, 775 and 776, respectively. Cable harness 773 includes at least three links: a link between network switch devices 711 and 714, a link between network switch devices 711 and 716, and a link between network switch devices 714 and 716. Network switch devices 711, 712 and 713 are coupled to cable harness 783 via cable harness switches 784, 785 and 786, respectively. Cable harness 783 includes at least three links: a link between network switch devices 711 and 712, a link between network switch devices 711 and 713, and a link between network switch devices 712 and 713. Network switch devices 714, 715 and 716 are coupled to cable harness 793 via cable harness switches 794, 795 and 796, respectively. Cable harness 793 includes at least three links: a link between network switch devices 714 and 715, a link between network switch devices 714 and 716, and a link between network switch devices 715 and 716.

Each of cable harness switches 764, 765, 766, 774, 775, 776, 784, 785, 786, 794, 795 and 796 are similar to cable harness switches discussed herein. For example, cable harness switches 764, 765, 766, 774, 775, 776, 784, 785, 786, 794, 795 and 796 can include a circuit switch module (not shown) and be similar to the cable harness switches discussed in relation to FIGS. 4 and 5. The circuit switch module or circuit switch modules of each cable harness switch is controlled (or configured or programmed) based on signals provided to that cable harness by a controller. That is, controller (labeled “CTRL”) 762 provides control signals to cable harness switches 764, 765 and 766; controller (labeled “CTRL”) 772 provides control signals to cable harness switches 774, 775 and 776; controller (labeled “CTRL”) 782 provides control signals to cable harness switches 784, 785 and 786; and controller (labeled “CTRL”) 792 provides control signals to cable harness switches 794, 795 and 796. To accommodate exchange of signals between cable harness switches and controllers, of cable harnesses 763, 773, 783 and 793 can include links between controllers 762, 772, 782 and 792, respectively, and the cable harness switches coupled to or included in those cable harnesses.

More specifically, for example, controller 762 provides control (or configuration) signals to cable harness switches 764, 765 and 766 to configure circuit switch modules at those cable harnesses to define network circuits including (or from) the links of cable assembly 763. For example, if network switch device 712 becomes disabled, controller 762 can provide control signals to cable harness switch 764 to define a network circuit including a link between network switch devices 712 and 713 and a link between network switch devices 712 and 715, as discussed herein, such that network switch devices 713 and 715 can communicate one with another (i.e., exchange signals representing data) via the network circuit. That is, cable harness switch 764 can couple the links one to another in response to the control signals.

As illustrated in FIG. 7, controllers 762, 772, 782 and 792 are in communication with management module (labeled “MGMT”) 750. Management module 750 can be a hardware module such as a computing device, a software module such as a software application hosted at a computing device, and/or a combination thereof. Management module 750 provides configuration commands (or instructions) to controllers 762, 772, 782 and 792 via links 761, 771, 781 and 791, respectively. That is, management module 750 functions as a central (with respect to controllers 762, 772, 782 and 792) management entity or authority that specifies the configuration (i.e., which input ports are couple to which output ports of a circuit switch module) of cable harness switches within communications network 700. In other words, management module 750 provides configuration commands that describe or define the configuration of the cable harness switches to controllers 762, 772, 782 and 792, and controllers 762, 772, 782 and 792 interpret those configuration commands and provide configuration signals based on (or associated with) those configuration commands to the cable harness switches operatively coupled to controllers 762, 772, 782 and 792. Alternatively, controllers 762, 772, 782 and 792 can forward all or a portion of those commands to the cable harness switches operatively coupled to controllers 762, 772, 782 and 792. For example, the cable harness switches can each include an integrated controller that interprets configuration commands and provides signals to a circuit switch module to configure the circuit switch module (not shown) of the cable harness switch.

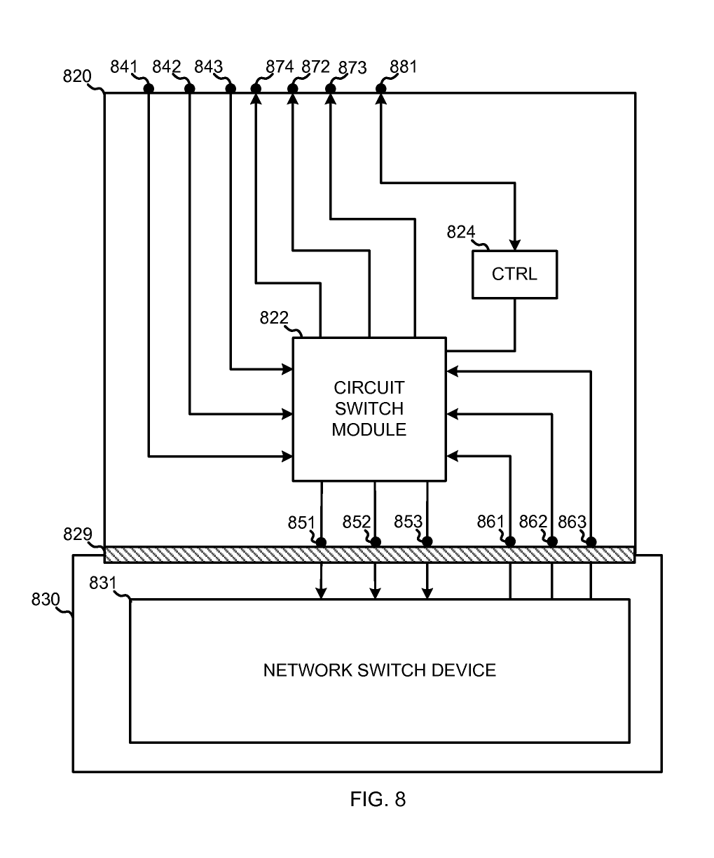

FIG. 8 is a schematic block diagram of another cable harness switch and a network switch device, according to an embodiment. Cable harness switch 820 includes circuit switch module 822 and controller (labeled “CTRL”) 824. Additionally, cable harness switch 820 includes input ports 841, 842, 843, 861, 862 and 863 and output ports 851, 852, 853, 871, 872 and 873. Circuit switch module 822 is coupled to ports 841, 842, 843, 861, 862 and 863 at input ports (not shown) of circuit switch module 822 and ports 851, 852, 853, 871, 872 and 873 at input ports (not shown) of circuit switch module 822 via one or more links such as, for example, cables (e.g., electrical cables or fiber optic cables), wires, circuit board traces, waveguides within a substrate such as a circuit board, and/or other links. Moreover, cable harness switch 820 is coupled to network switch device 831 of network device 830 through connector module 829 via output ports 851, 852 and 853 and input ports 861, 862 and 863.

Connector module 829 can include any of a variety of connectors and/or can include multiple portions. That is, one portion of connector module 829 can be included at cable harness switch 820 and another portion of connector module 829 can be included at network device 830. In some embodiments, connector module 829 includes multiple connectors. For example, each of ports 851, 852, 853, 861, 862 and 863 can be couple to the network device 830 via a different connector of connector module 829. In some examples, connector module 829 includes output ports 851, 852 and 853 and input ports 861, 862 and 863. In other example, output ports 851, 852 and 853 and input ports 861, 862 and 863 are coupled to connector module 820.

Circuit switch module 822 is configured (or programmed) by controller 824. That is, controller 824 receives configuration commands (or instructions) from a management entity directly or indirectly via other controllers at port 881 and provides signals to circuit switch module 822 to configure circuit switch module 822. For example, controller 824 can provide signals to circuit switch module 822 to configure circuit switch module 822 to couple port 841 to output port 872. Thus, signals received via port 841 are transmitted at port 872.

Additionally, as illustrated in FIG. 8, port 881 can be a bidirectional port. In addition to providing configuration signals to circuit switch module 822, controller 824 can provide configuration information via port 881. For example, a management module can query or request a configuration of cable harness switch 820 (i.e., information related to or describing the configuration of circuit switch module 822), and controller 824 can provide information that describes the configuration of cable harness switch 820 to the management module. More specifically, for example, controller 824 or cable harness switch 820 can include a memory and controller 824 can store information related to the configuration of cable harness switch 820 at that memory and provide that information in response to such a request. Alternatively, for example, controller 824 can query circuit switch module 822 for information related to the configuration of circuit switch module 822, and provide that information to the management module.

Controller 824 can communicate with a management module and circuit switch module 822 using a variety of protocols or methodologies. For example, controller 824 can communicate with a management module and/or circuit switch module 822 using a protocol such as a Two-Wire protocol, a Serial Peripheral Interface protocol, a One-Wire protocol, a serial protocol such as RS-232 or RS-482, or some other protocol. Additionally, controller 824 can communicate with circuit switch module 822 using a parallel interface in which the logic levels of one or more ports of circuit switch module 822 (e.g., control pins or ports of circuit switch module 822 represented by port 882) define which input ports of circuit switch module 822 are coupled to which output ports of circuit switch module 822.

Typically, ports of circuit switch module 822 can be coupled to another port or be not connected or open. Thus, in the examples below, although the not connected or open configuration of a port is not specifically recited, the ports of circuit switch module 822 typically are capable of being configuration in the open configuration. Moreover, each output port of circuit switch module 822 can typically be coupled to one input port of circuit switch module 822. That is, if one input port of circuit switch module 822 is coupled to an output port of circuit switch module 822, another input port of circuit switch module 822 cannot be coupled to that output port. Thus, in examples discussed below in which an input port can be coupled to any of a variety of output ports, it should be understood that that input port is not coupled to an output port to which another input port is coupled.

In some embodiments, circuit switch module 822 can be configured to couple any input port (i.e., ports 841, 842, 843, 861, 862 and 863) to any output port (851, 852, 853, 871, 872 and 873) of circuit switch module 822. In some embodiments, circuit switch module 822 includes two groups of input ports and two groups of output ports. Any input port from the first group of input ports can be coupled to any output port from the first group of output ports and the second group of output ports and any input port from the second group of input ports can be coupled to any output port from the first group of output ports. Said differently, any input port from the first group of input ports can be coupled to an output port (e.g., a specific output port or any output port) from a set of ports defined by the union of the first group of output ports and the second group of output ports. Also, any input port from the second group of input ports can be coupled to any output port from the first group of output ports. That is, an output port from the first group of output ports can be coupled to an input port from a set of ports defined by the union of the first group of input ports and the second group of input ports.

For example, the first group of input ports can be coupled to ports 841, 842 and 843, the second group of input ports can be coupled to ports 861, 862 and 863, the first group of output ports can be coupled to ports 871, 872 and 873, and the second group of output ports can be coupled to ports 851, 852 and 853. Thus, for example, circuit switch module 822 can couple port 842 to any of ports 871, 872, 873, 851, 852 and 853. Circuit switch module 822 can couple Port 862, however, to any of ports 871, 872 and 873.

Alternatively, for example, in some embodiments, circuit switch module 822 includes two groups of input ports and two groups of output ports. Any input port from the first group of input ports can be coupled to any output port from the first group of output ports or to an output port from the second group of output ports that is associated with that input port. Also, any input port from the second group of input ports can be coupled to an output port from the first group of output ports that is associated with that input port. For example, the first group of input ports can be coupled to ports 841, 842 and 843, the second group of input ports can be coupled to ports 861, 862 and 863, the first group of output ports can be coupled to ports 871, 872 and 873, and the second group of output ports can be coupled to ports 851, 852 and 853. Circuit switch module 822 can coupled port 843 to any of ports 871, 872 and 873 or to port 853 that is associated with port 843. Similarly, circuit switch module 822 can couple port 841 to any of ports 871, 872 and 873 or to port 851 that is associated with port 841. Moreover, circuit switch module 822 can couple port 842 to any of ports 871, 872 and 873 or to port 852 that is associated with port 842. Furthermore, circuit switch module 822 can couple ports 861, 862 and 863 to ports 871, 872, and 873, respectively. In other words, ports 861, 862 and 863 are associated, respectively, with ports 871, 872, and 873.

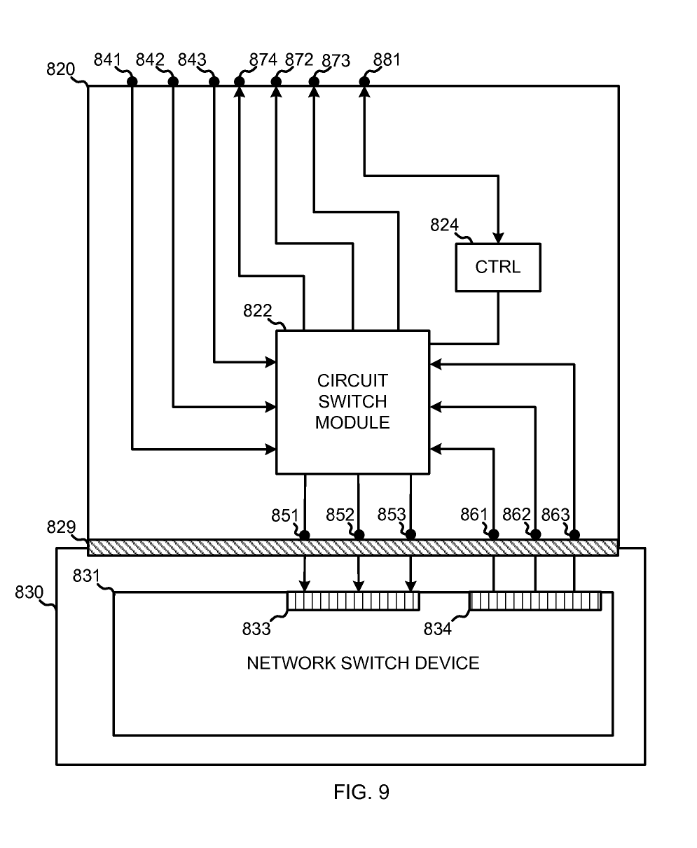

FIG. 9 is a schematic block diagram of another cable harness switch and a network switch device, according to an embodiment. In the example of cable harness switch 820 and network device 830 illustrated in FIG. 9, network switch device 831 includes opto-electrical converter 833 and electro-optical converter 834. Opto-electrical converter 833 converts optical signals received via ports 851, 852 and 853 to electrical signals that are processed at network switch device 831. Electro-optical converter 834 converts electrical signals to optical signals that are transmitted via ports 861, 862 and 863. In other words, ports 841, 842, 843, 851, 852, 853, 861, 862, 863, 871, 872 and 873 are optical ports. That is, optical signals are transferred via ports 841, 842, 843, 851, 852, 853, 861, 862, 863, 871, 872 and 873. For example, fiber optic cables can be coupled to ports 841, 842, 843, 871, 872 and 873.

Moreover, circuit switch module 822 is an optical circuit switch module. That is, circuit switch module 822 optically couples one or more input ports 841, 842, 843, 861, 862 and 863 with one or more output ports 851, 852, 853, 871, 872 and 873. Said differently, optical signals are transferred from an input port of circuit switch module 822 to an output port of switch module 822. Thus, cable harness switch 820 can be used to optically couple two optical links to define a network circuit without converting optical signals exchanged via those optical links to electrical signals. In other words, cable harness switch 820 is an optical switch with respect to links coupled to ports 841, 842, 843, 871, 872 and 873.

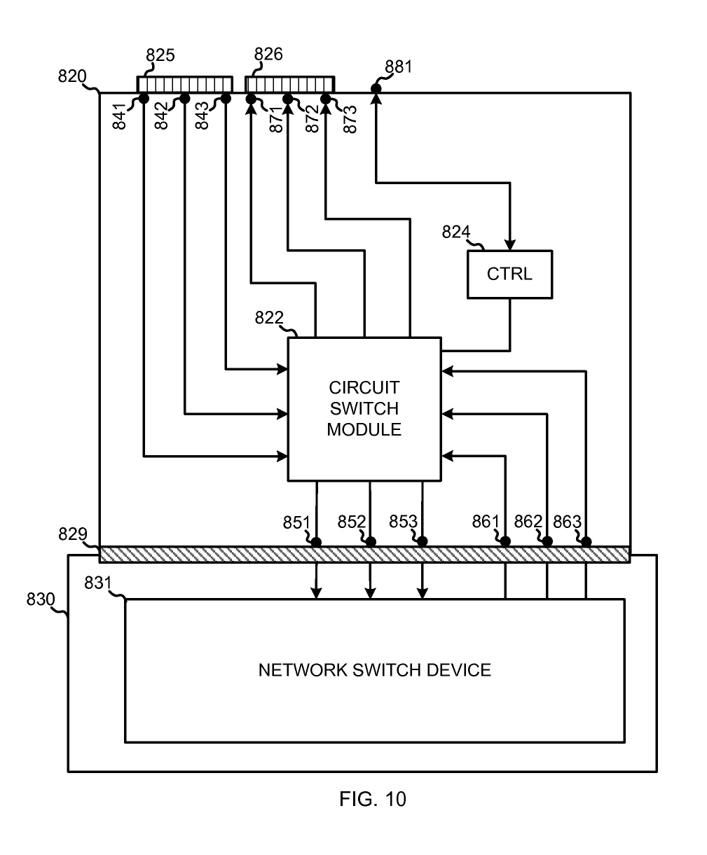

FIG. 10 is a schematic block diagram of another cable harness and a network switch device, according to an embodiment. In the example of cable harness switch 820 illustrated in FIG. 10, cable harness switch 820 includes opto-electrical converter 825 and electro-optical converter 826. Opto-electrical converter 825 converts optical signals received at cable harness switch 820 (e.g., via optical links (not shown) operatively coupled to cable harness switch 820 at opto-electrical converter 825) to electrical signals that are transmitted via ports 841, 842 and 843. Electro-optical converter 826 converts electrical signals that are transmitted via ports 871, 872 and 873 to optical signals. The resulting optical signals are transmitted via optical links operatively coupled to cable harness switch 820 at electro-optical module 826. In other words, ports 841, 842, 843, 851, 852, 853, 861, 862, 863, 871, 872 and 873 are electrical ports. That is, optical signals are received at opto-electrical converter 825 and transmitted at electro-optical converter 826 and electrical signals are transferred via ports 841, 842, 843, 851, 852, 853, 861, 862, 863, 871, 872 and 873.

As an example, an optical signal is received via a link operatively coupled to opto-electrical converter 825 and a corresponding electrical signal is output at port 841. Circuit switch module 822 is configured to couple port 841 to port 872 based on configuration signals received from controller 824. Accordingly, the electrical signal is input to circuit switch module 822 at port 841 and is output from circuit switch module 822 at port 873. The electrical signal is received at electro-optical converter 826 and a corresponding optical signal (i.e., an optical signal substantially identically to or representing the same information or data as the optical signal received at opto-electrical converter 825) is output to a link operatively coupled to electro-optical converter 826.

In contrast to the example illustrated in FIG. 9, the optical signal received at opto-electrical converter 825 is converted to an electrical signal, circuit switched (or routed) at cable harness switch 820, and converted back to an optical signal at electro-optical converter 826. Because the conversions at opto-electrical converter 825 and electro-optical converter 826 are not instantaneous, these intermediary conversions can add latency to the network circuits (i.e., links coupled one to another via cable harness switch 820) defined at cable harness switch 820.

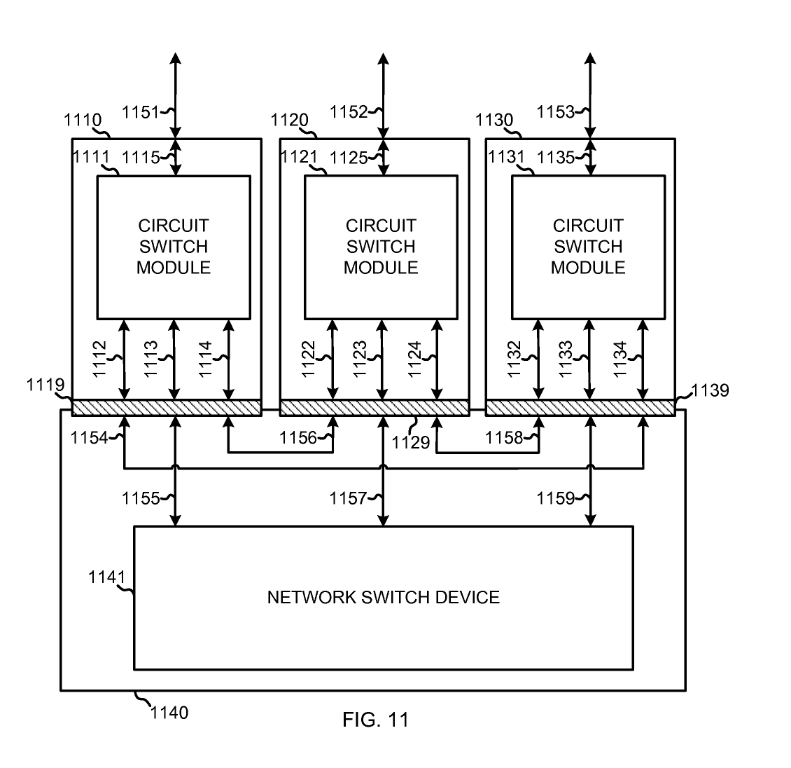

FIG. 11 is a schematic block diagram of a group of cable harness switches and a network switch device, according to an embodiment. Cable harness switches 1110, 1120 and 1130 are operatively coupled to network device 1140 via connectors 1119, 1129 and 1139. Connectors 1119, 1129 and 1139 are each similar to, for example, connector 829 as discussed above in relation to FIG. 8. More specifically, links 1112 (i.e., a group of links coupled to input ports and/or output ports at circuit switch module 1111 and to connector 1119) are operatively coupled to links 1154 (i.e., a group of links coupled to connector 1119 and connector 1139) via connector 1119, links 1113 (i.e., a group of links coupled to input ports and/or output ports at circuit switch module 1111 and to connector 1119) are operatively coupled to links 1155 (i.e., a group of links coupled to input ports and/or output ports at network switch device 1141 and to connector 1119) via connector 1119, and links 1114 (i.e., a group of links coupled to input ports and/or output ports at circuit switch module 1111 and to connector 1119) are operatively coupled to links 1156 (i.e., a group of links coupled to connector 1119 and connector 1129) via connector 1119. Links 1122 (i.e., a group of links coupled to input ports and/or output ports at circuit switch module 1121 and to connector 1129) are operatively coupled to links 1156 via connector 1129, links 1123 (i.e., a group of links coupled to input ports and/or output ports at circuit switch module 1121 and to connector 1129) are operatively coupled to links 1157 (i.e., a group of links coupled to input ports and/or output ports at network switch device 1141 and to connector 1129) via connector 1129, and links 1124 (i.e., a group of links coupled to input ports and/or output ports at circuit switch module 1121 and to connector 1129) are operatively coupled to links 1158 (i.e., a group of links coupled to connector 1129 and connector 1139) via connector 1129. Links 1132 (i.e., a group of links coupled to input ports and output ports at circuit switch module 1131 and to connector 1139) are operatively coupled to links 1158 via connector 1139, links 1133 (i.e., a group of links coupled to input ports and/or output ports at circuit switch module 1131 and to connector 1139) are operatively coupled to links 1159 (i.e., a group of links coupled to input ports and/or output ports at network switch device 1141 and to connector 1139) via connector 1139, and links 1134 (i.e., a group of links coupled to input ports and/or output ports at circuit switch module 1131 and to connector 1139) are operatively coupled to links 1154 via connector 1139.

Cable assembly 1151 is operatively coupled to circuit switch module 1111 via links 1115 (i.e., a group of links coupled to input ports and/or output ports at circuit switch module 1111) at cable harness switch 1110. Similarly, cable assembly 1152 is operatively coupled to circuit switch module 1121 via links 1125 (i.e., a group of links coupled to input ports and/or output ports at circuit switch module 1121) at cable harness switch 1120, and cable assembly 1153 is operatively coupled to circuit switch module 1131 via links 1135 (i.e., a group of links coupled to input ports and/or output ports at circuit switch module 1131) at cable harness switch 1130.

In addition to cable assembly 1151, circuit switch module 1111 is operatively coupled to network switch device 1141 via links 1113 and links 1155. Similarly, in addition to cable assembly 1152, circuit switch module 1121 is operatively coupled to network switch device 1141 via links 1123 and links 1157. Additionally, in addition to cable assembly 1153, circuit switch module 1131 is operatively coupled to network switch device 1141 via links 1133 and links 1159. Furthermore, circuit switch module 1111 and circuit switch module 1121 are operatively coupled one to another via links 1114, links 1156 and links 1122; circuit switch module 1111 and circuit switch module 1131 are operatively coupled one to another via links 1112, links 1154 and links 1134; and circuit switch module 1121 and circuit switch module 1131 are operatively coupled one to another via links 1124, links 1158 and links 1132.

Similar to circuit switch modules discussed above in relation to, for example, FIGS. 4, 5, 8, 9 and 10, circuit switch modules 1111, 1121 and 1131 can couple input ports of those circuit switch modules to output ports of those circuit switch modules. For example, circuit switch module 1221 can couple an input port from input ports coupled to links 1125 to an output port from output ports coupled to links 1122, 1123 and 1124. Thus, signals received at that input port can be output to network switch device 1141, circuit switch module 1111 or circuit switch module 1131 depending on the configuration of circuit switch module 1121. Circuit switch modules 1111 and 1131 can be similarly configured to couple input ports to output ports.

Links 1154, 1156 and 1158 can be links such as electrically conductive cable or fiber optic cables within network device 1140. Alternatively, for example, links 1154, 1156 and 1158 can be links such as electrically conductive traces at a circuit board or optical waveguides at a circuit board.

Because links 1154, 1156 and 1158 couple connectors 1119, 1129 and 1139 one to another, cable harness switches 1110, 1120 and 1130 can define network circuits that span multiple cable harnesses. As an example, an input port from ports coupled to links 1135 that is operatively coupled to a link from cable assembly 1153 can be coupled to an output port from ports coupled to links 1134 at circuit switch module 1131. That output port is coupled to a port from ports coupled to links 1154 via connector 1139, which is coupled to an input port from ports coupled to links 1112 via connector 1119. The input port from ports coupled to links 1112 can be coupled to an output port from ports coupled to links 1115 at switch module 1111. The output port from ports coupled to links 1115 is operatively coupled to a link from cable assembly 1151. Thus, a network circuit that includes the link from cable assembly 1153 and the link from cable assembly 1151 is defined collectively at circuit switch modules 1111 and 1131. In other words, the network circuit includes or traverses (or passes through) circuit switch modules 1111 and 1131.

As another example, rather than the input port from ports coupled to links 1112 being coupled to an output port from ports coupled to links 1115 at switch module 1111, that input port can be coupled to an output port from ports coupled to links 1114. That output port is coupled to a port from ports coupled to links 1156 via connector 1119, which is coupled to an input port from ports coupled to links 1122 via connector 1129. Circuit switch module 1121 can be configured to couple the input port from ports coupled to links 1122 to an output port from ports coupled to links 1125. The output port from ports coupled to links 1125 is operatively coupled to a link from cable assembly 1152. Thus, a network circuit that includes the link from cable assembly 1153 and the link from cable assembly 1152 is defined collectively at circuit switch modules 1111, 1121 and 1131. In other words, the network circuit includes or traverses (or passes through) circuit switch modules 1111, 1121 and 1131.

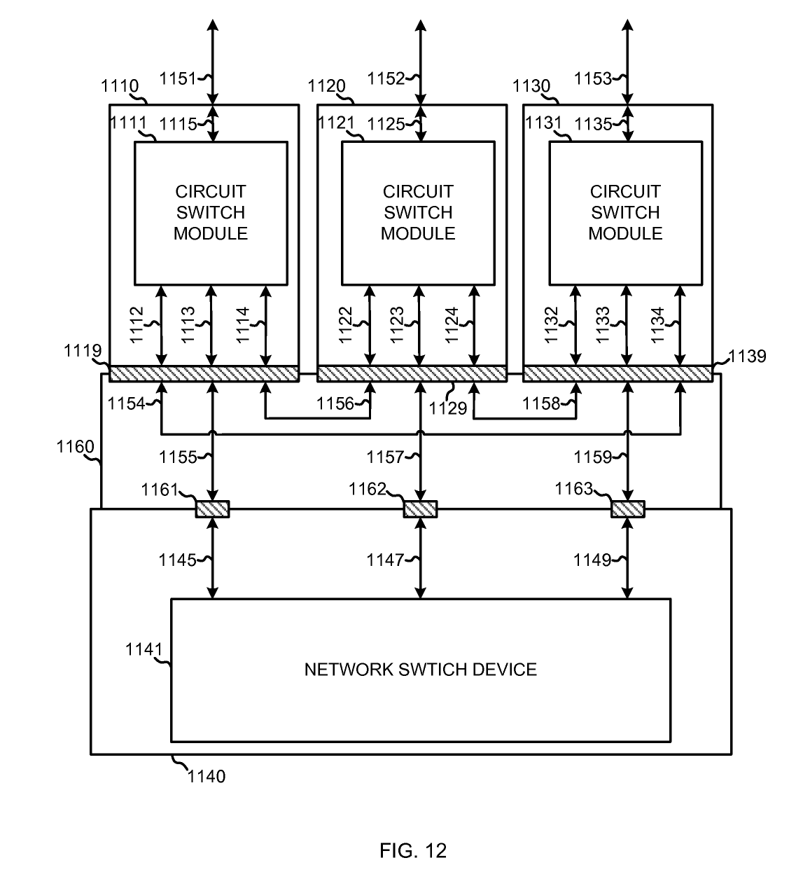

As illustrated in FIG. 11, the links via which cable harness switches 1110, 1120 and 1130 are operatively coupled are included at network device 1140. FIG. 12 is a schematic block diagram of the group of cable harness switches and the network switch device of FIG. 11, according to another embodiment. As illustrated in FIG. 12, cable harness switches 1110, 1120 and 1130 are operatively coupled to network device 1140 via bypass block 1160. In other words, cable harness switches 1110, 1120 and 1130 are operatively coupled to bypass block 1160 at connectors 1119, 1129 and 1139, and bypass block 1160 is coupled to network device 1140 at connectors 1161, 1162 and 1163. More specifically, links 1155 are operatively coupled to links 1145 and, therefore, to network switch device 1141 via connector 1161. Links 1157 are operatively coupled to links 1147 and, therefore, to network switch device 1141 via connector 1162. Additionally, links 1159 are operatively coupled to links 1149 and, therefore, to network switch device 1141 via connector 1163. In some embodiments, connectors 1161, 1162 and 1163 can be a single connector, a connector module, and/or more of fewer connectors than illustrated in FIG. 12.

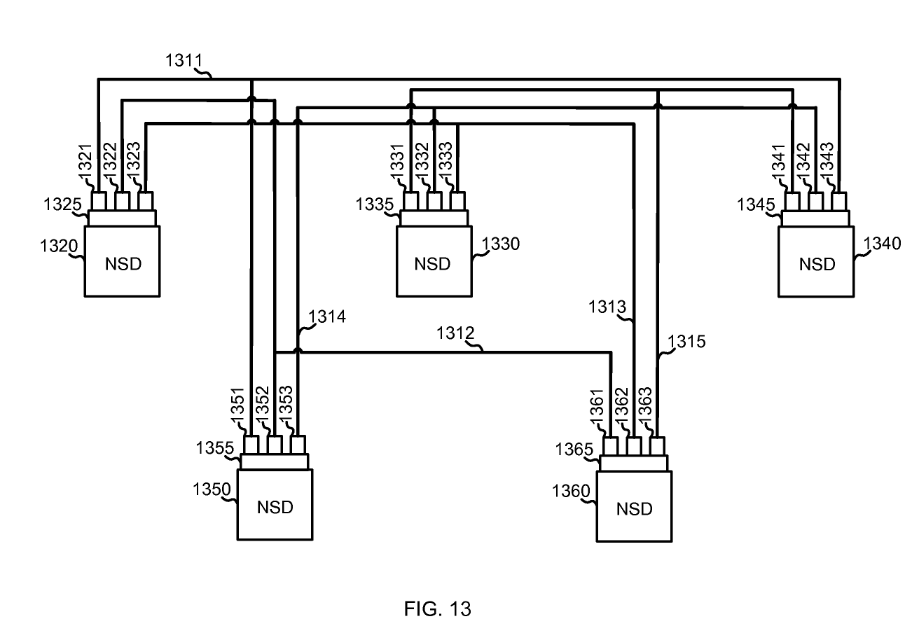

Embodiments such as those illustrated in FIGS. 11 and 12 allow network circuits to be defined that include links from separate cable assemblies. In other words, network circuits can span multiple cable assemblies and cable harnesses. For example, FIG. 13 is a schematic block diagram of a communications network, according to an embodiment. FIG. 13 illustrates a communications network including network switch devices 1320, 1330, 1340, 1350 and 1360.

Network switch device 1320 is coupled to cable harnesses 1311, 1312 and 1313 via cable harness switches 1321, 1322 and 1323, respectively, via bypass block 1325. Cable harness switches 1321, 1322 and 1323 are operatively coupled one to another via bypass block 1325, for example, as illustrated in FIG. 12. Network switch device 1330 is coupled to cable harnesses 1315, 1314 and 1313 via cable harness switches 1331, 1332 and 1333, respectively, via bypass block 1335. Cable harness switches 1331, 1332 and 1333 are operatively coupled one to another via bypass block 1335, for example, as illustrated in FIG. 12. Network switch device 1340 is coupled to cable harnesses 1311, 1314 and 1315 via cable harness switches 1341, 1342 and 1343, respectively, via bypass block 1345. Cable harness switches 1341, 1342 and 1343 are operatively coupled one to another via bypass block 1345, for example, as illustrated in FIG. 12. Network switch device 1350 is coupled to cable harnesses 1311, 1312 and 1314 via cable harness switches 1351, 1352 and 1353, respectively, via bypass block 1355. Cable harness switches 1351, 1352 and 1353 are operatively coupled one to another via bypass block 1355, for example, as illustrated in FIG. 12. Network switch device 1360 is coupled to cable harnesses 1312, 1313 and 1315 via cable harness switches 1361, 1362 and 1363, respectively, via bypass block 1365. Cable harness switches 1361, 1362 and 1363 are operatively coupled one to another via bypass block 1365, for example, as illustrated in FIG. 12.

In some embodiments, a cable assembly and cable harnesses operatively coupled to that cable assembly can be collectively referred to as a cable assembly. Thus, for example cable harness 1311 and cable harness switches 1321, 1343 and 1351 can collectively be referred to as a cable assembly. As discussed in relation to the example illustrated in FIG. 13, the term cable assembly is used to refer to a group of cables that are each operatively coupled to a cable harness switch.

Each of cable harnesses 1311, 1312, 1313, 1314 and 1315 includes a different (or unique from the other cable assemblies) group of links (e.g., electrically conductive cables or fiber optic cables). Thus, for example, network switch device 1360 is not in communication with any links from cables assemblies 1311 and 1314. However, a network circuit can be defined within the communications network by one or more cable harnesses to couple network switch device 1360 with a link from, for example, cable harness 1311.

More specifically, for example, cable harness switch 1361 can be configured to couple an input port that is in communication with network switch device 1360 to an output port that is in communication with a link of cable harness 1312. Additionally, cable harness switch 1322 can be configured to couple an input port with which that link of cable harness 1312 is in communication to an output port that is in communication with an input port of cable harness switch 1321 via bypass block 1325. Cable harness switch 1321 can be configured to couple that input port to an output port that is in communication with a link of cable harness 1311. Thus, network switch device 1360 can transmit signals representing data to a link of cable harness 1311 without an intermediary network switch device. That is, the signals can be transmitted from network switch device 1360 to the link of cable harness 1311 directly (i.e., without packet switching at a network switch device). Moreover, although the example above was discussed in relation to two cable harnesses and network switch device, other network circuits can be defined that include additional cable harnesses and/or network switch devices.

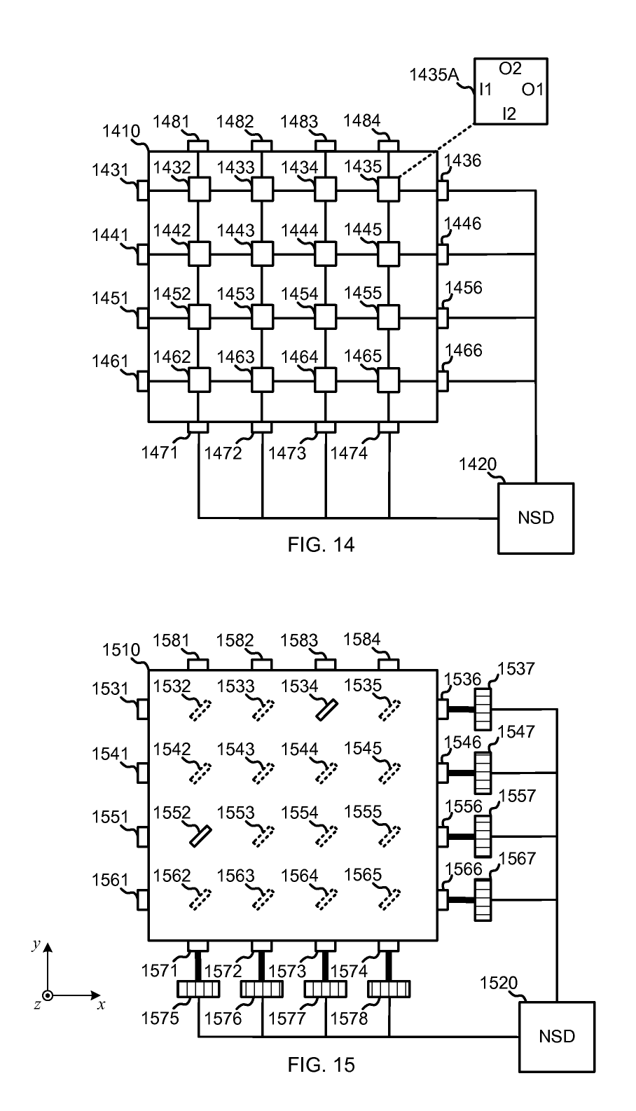

FIG. 14 is a schematic block diagram of a circuit switch module and a network switch device, according to an embodiment. Circuit switch module 1410 includes input ports 1431, 1441, 1451, 1461, 1471, 1472, 1472, 1473 and 1474 and output ports 1436, 1446, 1456, 1466, 1481, 1482, 1483 and 1484. Additionally, circuit switch module 1410 includes circuit switch elements 1432, 1433, 1434, 1435, 1442, 1443, 1444, 1445, 1452, 1453, 1454, 1455, 1462, 1463, 1464 and 1465. The circuit switch elements of circuit switch module 1410 can be any of a variety of components, modules, elements, and/or combinations thereof that can be configured (or programmed) to couple an input port to one or more output ports such that a signal received at the input port is transmitted to the coupled output port or ports. As a specific example, a circuit switch element can couple an input port to any one output port of several output ports. Circuit switch elements can include, for example, a group of transistors, logic gates, multiplexors, demultiplexors, memories, and/or other electrical components. Alternatively, for example, circuit switch elements can include mirrors, piezo-electric motors or solenoids, microelectromechanical systems (“MEMS”) devices or components, lasers, photodetectors, optical sensors, and/or other optical components.

Each circuit switch element includes a group of ports. For example, circuit switch element 1435 is shown in an enlarged view as circuit switch element 1435A. As illustrated at circuit switch element 1435A, each of circuit switch elements 1432, 1433, 1434, 1435, 1442, 1443, 1444, 1445, 1452, 1453, 1454, 1455, 1462, 1463, 1464 and 1465 includes input ports I1 and I2 and output ports O1 and O2. The ports of the circuit switch elements of circuit switch module 1410 are discussed herein with reference to the orientation of ports I1, I2, O1 and O2 at circuit switch element 1435A. That is, for example, circuit switch element 1444 is coupled to circuit switch element 1434 via port O2 of circuit switch element 1444, to circuit switch element 1445 via port O1 of circuit switch element 1444, to circuit switch element 1443 via port I1 of circuit switch element 1444, and to circuit switch element 1454 via port I2 of circuit switch element 1444.

Furthermore, circuit switch module 1410 is in communication with network switch device 1420 via output ports 1436, 1446, 1456 and 1466 and input ports 1471, 1472, 1473 and 1474. That is, network switch device 1420 receives signals from circuit switch device 1410 via output ports 1436, 1446, 1456 and 1466 and transmits signals to circuit switch device 1410 via input ports 1471, 1472, 1473 and 1474.

Circuit switch elements 1432, 1433, 1434, 1435, 1442, 1443, 1444, 1445, 1452, 1453, 1454, 1455, 1462, 1463, 1464 and 1465 couple input ports 1431, 1441, 1451, 1461, 1471, 1472, 1472, 1473 and 1474 to output ports 1436, 1446, 1456, 1466, 1481, 1482, 1483 and 1484. That is, circuit switch elements 1432, 1433, 1434, 1435, 1442, 1443, 1444, 1445, 1452, 1453, 1454, 1455, 1462, 1463, 1464 and 1465 can be configured (e.g., in response to signals from a controller) to define circuits or signal paths from an input port through one or more circuit switch elements to an output port.

For example, port 1451 can be coupled to port 1482, port 1431 can be coupled to port 1436, and port 1471 can be coupled to port 1481 as follows. Circuit switch element 1452 is configured to couple port I1 of circuit switch element 1452 to port O1 of circuit switch element 1452. As illustrated in FIG. 14, port O1 of circuit switch element 1452 is coupled to port I1 of circuit switch element 1453. Circuit switch element 1453 is configured to couple port I1 of circuit switch element 1453 to port O2 of circuit switch element 1453. Each of circuit switch elements 1443 and 1433 are configured to couple its port I2 to its port O2. Additionally, as illustrated in FIG. 14, port O2 of circuit switch element 1453 is coupled to port I2 of circuit switch element 1443, port O2 of circuit switch element 1443 is coupled to port I2 of circuit switch element 1433, and port O2 of circuit switch element 1433 is coupled to port 1482. Thus, port 1451 is couple to port 1482 via circuit switch elements 1452, 1453, 1443 and 1433.

Moreover, each of circuit switch elements 1432, 1433, 1434 and 1435 is configured to couple its port I1 to its port O1. As illustrated in FIG. 14, port 1431 is coupled to port I1 of circuit switch element 1432, port O1 of circuit switch element 1432 is coupled to port I1 of circuit switch element 1433, port O1 of circuit switch element 1433 is coupled to port I1 of circuit switch element 1434, port O1 of circuit switch element 1434 is coupled to port I1 of circuit switch element 1435, and port O1 of circuit switch element 1435 is coupled to port 1436. Additionally, each of circuit switch elements 1462, 1452, 1442 and 1432 is configured to couple its port I2 to its port O2. As illustrated in FIG. 14, port 1471 is coupled to port I2 of circuit switch element 1462, port O2 of circuit switch element 1462 is coupled to port I2 of circuit switch element 1452, port O2 of circuit switch element 1452 is coupled to port I2 of circuit switch element 1442, port O2 of circuit switch element 1442 is coupled to port I2 of circuit switch element 1432, and port O2 of circuit switch element 1432 is coupled to port 1436. Thus, port 1431 is coupled via circuit switch elements 1432, 1433, 1434 and 1435 to port 1436 and port 1471 is coupled via circuit switch elements 1462, 1452, 1442 and 1432 to port 1481.

In some embodiments, each circuit switch element of circuit switch elements 1432, 1433, 1434, 1435, 1442, 1443, 1444, 1445, 1452, 1453, 1454, 1455, 1462, 1463, 1464 and 1465 can couple either input port I1 or 12 to either output port O1 and 02. Thus, circuit switch elements 1432, 1433, 1434, 1435, 1442, 1443, 1444, 1445, 1452, 1453, 1454, 1455, 1462, 1463, 1464 and 1465 can couple, for example, input port 1461 of circuit switch module 1410 to any output port (i.e., any of ports 1481, 1482, 1483, 1484, 1436, 1446, 1456 and 1466) of circuit switch module 1410. In other embodiments, a circuit switch element can couple input port I1 to either output port O1 or 02, but input port I2 to only output port O2. Thus, some input ports of circuit switch module 1410 can be coupled to specific output ports of circuit switch module 1410. In other words, some input ports of circuit switch module 1410 are associated with specific output ports of circuit switch module 1410.

In one example, each switch element of circuit switch elements 1432, 1433, 1434, 1435, 1442, 1443, 1444, 1445, 1452, 1453, 1454, 1455, 1462, 1463, 1464 and 1465 can couple input port I1 to either output port O1 or 02, but input port I2 to only output port O2. Thus, input port 1441 can be coupled to any output port in the group of output ports including ports 1481, 1482, 1483 and 1484, but only to output port 1446 in the group of output ports including ports 1436, 1446, 1456 and 1466. Similarly, input port 1474 can be coupled to only output port 1484 in the group of output ports including ports 1481, 1482, 1483 and 1484 and to no output port in the group of output ports including ports 1436, 1446, 1456 and 1466.

FIG. 15 is a schematic block diagram of an optical circuit switch module and a network switch device, according to an embodiment. Optical circuit switch module 1510 includes input ports 1531, 1541, 1551, 1561, 1571, 1572, 1572, 1573 and 1574 and output ports 1536, 1546, 1556, 1566, 1581, 1582, 1583 and 1584. Additionally, optical circuit switch module 1510 includes optical circuit switch elements 1532, 1533, 1534, 1535, 1542, 1543, 1544, 1545, 1552, 1553, 1554, 1555, 1562, 1563, 1564 and 1565. Optical circuit switch module 1510 is configured to receive optical signals at input ports 1531, 1541, 1551, 1561, 1571, 1572, 1572, 1573 and 1574 and transmit optical signals at output ports 1536, 1546, 1556, 1566, 1581, 1582, 1583 and 1584. As illustrated in FIG. 15, optical circuit switch module 1510 is operatively coupled to network switch device 1520 via opto-electrical converters 1537, 1547, 1557 and 1567 and via electro-optical converters 1575, 1576, 1577 and 1578. In other words, optical circuit switch module 1510 operates on optical signals and network switch device 1520 operates on electrical signals.

In the embodiment illustrated in FIG. 15, optical circuit switch elements 1532, 1533, 1534, 1535, 1542, 1543, 1544, 1545, 1552, 1553, 1554, 1555, 1562, 1563, 1564 and 1565 are mirrors that are mounted on MEMS devices that can actuate along the z-axis. That is, the mirrors can be raised and lowered along the z-axis relative to optical paths through optical circuit switch module 1510 defined by input ports 1531, 1541, 1551, 1561, 1571, 1572, 1572, 1573 and 1574 and output ports 1536, 1546, 1556, 1566, 1581, 1582, 1583 and 1584. Optical circuit switch elements illustrated in FIG. 15 with a dashed line are lowered (i.e., actuated in the negative z-direction) and optical circuit switch elements illustrated in FIG. 15 with a solid line are raised (i.e., actuated in the positive z-direction).

Thus, as illustrated in FIG. 15, an optical path is defined by port 1531, optical circuit switch element 1534, and port 1583. That is, an optical signal received at port 1531 propagates past (i.e., over) optical circuit switch elements 1532 and 1533 (which are in a lowered position relative to the optical path such that the optical signal does not interact with optical circuit switch elements 1532 and 1533) and is reflected by optical circuit switch element 1534 toward port 1583. In other words, port 1531 is coupled to port 1583 via optical circuit switch element 1534.

Similarly, port 1551 is coupled to port 1581 via optical circuit switch element 1552. More specifically, an optical path is defined by port 1551, optical circuit switch element 1552, and 1581. Thus, an optical signal received at port 1551 is reflected by optical circuit switch element 1552 toward port 1581 and propagates past (i.e., over) optical circuit switch elements 1542 and 1532 (which are in a lowered position relative to the optical path such that the optical signal does not interact with optical circuit switch elements 1542 and 1532).

Port 1541 is coupled to port 1546 because each of optical circuit switch elements 1542, 1543, 1544 and 1545 are in a lowered position relative to the optical path defined by ports 1541 and 1546. Thus, optical signals received at port 1541 propagate through optical circuit switch module 1510 to port 1546. Similarly, port 1561 is coupled to port 1566, port 1572 is coupled to port 1582, and port 1578 is coupled to port 1584. Although a specific configuration of optical circuit switch module 1510 is illustrated in FIG. 15, optical circuit switch elements 1532, 1533, 1534, 1535, 1542, 1543, 1544, 1545, 1552, 1553, 1554, 1555, 1562, 1563, 1564 and 1565 are configurable and, thus, other configurations (e.g., different arrangements of raised and lowered optical circuit switch elements) are possible within optical circuit switch module 1510.

While certain embodiments have been shown and described above, various changes in form and details may be made. For example, some features of embodiments that have been described in relation to one embodiment can be useful to other embodiments. More specifically, examples and features thereof discussed in relation to, for example, electrical circuit switches can be applicable to optical circuit switches. In other words, features and/or properties of various embodiments described in relation to one embodiment can be related to other embodiments. Furthermore, it should be understood that the systems and methods described herein can include various combinations and/or sub-combinations of the components and/or features of the different embodiments described. Thus, features described with reference to one or more embodiments can be combined with other embodiments described herein.

What is claimed is:

1. A cable harness switch, comprising:
a plurality of input ports, each input port from the plurality of input ports configured to be coupled to a network link;
a first plurality of output ports, each output port from the first plurality of output ports configured to be coupled to a network link;
a second plurality of output ports, each output port from the second plurality of output ports configured to be coupled to a network switch device; and
a circuit switch module operatively coupled to the plurality of input ports, the first plurality of output ports, and the second plurality of output ports to define a network circuit including an input port from the plurality of input ports and an output port from the first plurality of output ports and the second plurality of output ports.

2. The cable harness switch of claim 1, further comprising:
a controller in communication with the circuit switch module to receive configuration instructions and provide signals associated with the configuration instructions to the circuit switch module,
the circuit switch module operable to define the network circuit in response to the signals associated with the configuration instructions.

3. The cable harness switch of claim 1, wherein the circuit switch module is an optical circuit switch module.

4. The cable harness switch of claim 1, wherein the circuit switch module is an electrical circuit switch module.

5. The cable harness switch of claim 1, wherein the output port is any output port from the first plurality of output ports.

6. The cable harness switch of claim 1, wherein the output port is any output port from the first plurality of output ports and the second plurality of output ports.

7. The cable harness switch of claim 1, wherein the output port is any output port from the first plurality of output ports or an output port from the second plurality of output ports that is associated with the input port.

8. The cable harness switch of claim 1, wherein the plurality of input ports is a first plurality of input ports and the network circuit is a first network circuit, the cable harness apparatus further comprising:
a second plurality of input ports, each input port from the second plurality of input ports configured to be coupled to the network switch device,
the circuit switch module operatively operable to define a second network circuit including an input port from the second plurality of input ports and an output port from the first plurality of output ports.

9. The cable harness switch of claim 1, wherein the plurality of input ports is a first plurality of input ports, the network circuit is a first network circuit, and the output port is any output port from the first plurality of output ports, the cable harness apparatus further comprising:
a second plurality of input ports, each input port from the second plurality of input ports configured to be coupled to the network switch device,
the circuit switch module operatively operable to define a second network circuit including an input port from the second plurality of input ports and a output port from the first plurality of output ports, the output port from the first plurality of output ports different from the output port from the first plurality of output ports and the second plurality of output ports.

10. A cable harness system, comprising:
a plurality of cables;
a plurality of output ports, each output port from the plurality of output ports configured to be coupled to a network switch device; and
a circuit switch module operatively coupled to the plurality of cables and to the plurality of output ports to define a network circuit including a first cable from the plurality of cables and at least one of a second cable from the plurality of cables and an output port from the plurality of output ports.

11. The cable harness system of claim 10, further comprising:
a controller in communication with the circuit switch module to receive configuration instructions and provide signals associated with the configuration instructions to the circuit switch module,
the circuit switch module operable to define the network circuit in response to the signals associated with the configuration instructions.

12. The cable harness system of claim 10, wherein the second cable from the plurality of cables is any cable from the plurality of cables other than the first cable.

13. The cable harness system of claim 10, wherein:
the second cable from the plurality of cables is any cable from the plurality of cables other than the first cable; and
the output port from the plurality of output ports is associated with the first cable.

14. The cable harness system of claim 10, wherein the circuit switch module is an optical circuit switch module.

15. The cable harness system of claim 10, wherein the circuit switch module is an electrical circuit switch module.

16. The cable harness system of claim 10, wherein the network circuit is a first network circuit, the cable harness system further comprising:
a plurality of input ports, each input port from the plurality of input ports configured to be coupled to the network switch device, the circuit switch module operatively coupled to the plurality input ports,
the circuit switch module operable to define a second network circuit including an input port from the plurality of input ports and a third cable from the plurality of cables.

17. A cable harness switch, comprising:
a plurality of input ports, each input port from the plurality of input ports configured to be coupled to a network link;
a first plurality of output ports, each output port from the first plurality of output ports configured to be coupled to a network link;
a second plurality of output ports, each output port from the second plurality of output ports configured to be coupled to a network switch device;
a third plurality of output ports, each output port from the third plurality of output ports configured to be coupled to an input port of a different cable harness apparatus; and
a circuit switch module operatively coupled to the plurality of input ports, to the first plurality of output ports, to the second plurality of output ports, and to the third plurality of output ports to define a network circuit including an input port from the plurality of input ports and an output port from the first plurality of output ports, the second plurality of output ports, and the third plurality of output ports.

18. The cable harness switch of claim 17, wherein the output port from the first plurality of output ports, the second plurality of output ports, and the third plurality of output ports is any output port from the first plurality of output ports, an output port from the second plurality of output ports associated with the input port from the plurality of input ports, or any output port from the third plurality of output ports.

19. The cable harness switch of claim 17, wherein the plurality of input ports is a first plurality of input ports and the network circuit is a first network circuit, the cable harness apparatus further comprising:
a second plurality of input ports, each input port from the second plurality of input ports configured to be coupled to an output port of the different cable harness apparatus,
the circuit switch module operatively coupled to the second plurality of input ports to define a second network circuit including an input port from the second plurality of input ports and any output port from the first plurality of input ports.

20. The cable harness switch of claim 17, further comprising:
a controller in communication with the circuit switch module to receive configuration instructions and provide signals associated with the configuration instructions to the circuit switch module,
the circuit switch module operable to define the network circuit in response to the signals associated with the configuration instructions.
